(19) United States
(12) Patent Application Publication
(10) Pub. No.: US 2026/0215650 A1
(43) Pub. Date: Jul. 30, 2026

(54) SELF-CLEANING MAINTENANCE STATION AND SELF-CLEANING MAINTENANCE SYSTEM

(71) Applicant: Beijing Roborock Technology Co., Ltd., Beijing (CN)

(72) Inventors: Xing LI, Beijing (CN); Pan CHENG, Beijing (CN); Xiang LIN, Beijing (CN)

(73) Assignee: Beijing Roborock Technology Co., Ltd., Beijing (CN)

(21) Appl. No.: 19/144,866

(22) PCT Filed: Aug. 15, 2023
(86) PCT No.: PCT/CN2023/113114

§ 371 Date: Jun. 30, 2025

(30) Foreign Application Priority Data
Jan. 4, 2023 (CN) 202320015837.8

(51) Int. Cl. A47L 11/40; F26B 3/04; F26B 21/00; F26B 21/35; F26B 21/50

(52) U.S. Cl. CPC A47L 11/4091; F26B 3/04; F26B 21/001; F26B 21/35; F26B 21/50; A47L 2201/028

(57) ABSTRACT

A self-cleaning maintenance station is for an automatic cleaning apparatus, and includes a self-cleaning maintenance station body. The self-cleaning maintenance station body includes: an accommodating cavity, which is configured to accommodate at least part of the automatic cleaning apparatus when the automatic cleaning apparatus returns to the self-cleaning maintenance station; a body base, which is configured to support at least part of the automatic cleaning apparatus when the automatic cleaning apparatus returns to the self-cleaning maintenance station, wherein the body base is provided with a cleaning tank facing the accommodating cavity; and a drying fan, which is arranged in the self-cleaning maintenance station body, is located on the side of the accommodating cavity away from the body base, and is configured to push a dry airflow to at least part of the cleaning tank so as to dry the cleaning tank.

### CROSS-REFERENCE TO RELATED APPLICATION

The present application is a U.S. National Stage of International Application No. PCT/CN2023/113114, filed on Aug. 15, 2023, which is based on and claims priority to the Chinese Patent Application No. 202320015837. 8 filed on Jan. 4, 2023, the disclosure of both of which is incorporated herein by reference in its entirety.

### TECHNICAL FIELD

The present disclosure relates to the technical field of cleaning robots, and in particular to a self-cleaning maintenance station and a self-cleaning maintenance system.

### BACKGROUND ART

In recent years, with the development of science and technology, a variety of cleaning products have emerged continuously. These products reduce people's workload in cleaning and sweeping, meet their needs, and provide great convenience to their daily life. Among them, automatic cleaning devices are favored by people for their high level of intelligence.

The automatic cleaning device, such as a sweeping and mopping integrated robot, needs to return to a self-cleaning maintenance station: for collection of garbage in its dust box after completion of the sweeping; washing of a mop during cleaning or after completion of the cleaning; drying of the mop after completion of the cleaning; and for charging when the power is insufficient.

### SUMMARY OF THE INVENTION

The present disclosure is to provide a self-cleaning maintenance station for an automatic cleaning device. The self-cleaning maintenance station includes a self-cleaning maintenance station body, wherein the self-cleaning maintenance station body includes:
an accommodating cavity configured to accommodate at least a portion of the automatic cleaning device when the automatic cleaning device returns to the self-cleaning maintenance station;
a body base configured to support at least a portion of the automatic cleaning device when the automatic cleaning device returns to the self-cleaning maintenance station and provided with a washing tank facing the accommodating cavity; and
a drying fan arranged inside the self-cleaning maintenance station body, located on a side of the accommodating cavity away from the body base, and configured to propel drying airflow to at least a portion of the washing tank to dry the washing tank.

Some embodiments of the present disclosure provide a self-cleaning maintenance system. The self-cleaning maintenance system includes an automatic cleaning device and the self-cleaning maintenance station as described in the foregoing embodiments.

### BRIEF DESCRIPTION OF THE DRAWINGS

The accompanying drawings here are incorporated in and constitute part of the specification. They illustrate the embodiments consistent with the present disclosure and serve to, together with the specification, explain the principles of the present disclosure. Obviously, the accompanying drawings in the following description show only some embodiments of the present disclosure, and for those of ordinary skills in the art, other drawings may also be derived from these accompanying drawings without creative efforts. In the accompanying drawings:

FIG. 1 is a schematic diagram of an overall structure of a self-cleaning maintenance station according to an embodiment of the present disclosure;

FIG. 2 is a partial structural schematic diagram of the self-cleaning maintenance station according to an embodiment of the present disclosure;

FIG. 3 is a partial sectional structural schematic diagram of the self-cleaning maintenance station according to an embodiment of the present disclosure;

FIG. 4 is a schematic bottom view of the self-cleaning maintenance station with a cover plate closing an air duct not shown according to an embodiment of the present disclosure; and

FIG. 5 is a schematic bottom view of the self-cleaning maintenance station according to an embodiment of the present disclosure.

### DETAILED DESCRIPTION

To make the objects, technical solutions, and advantages of the present disclosure clearer, the present disclosure will be further described in detail below with reference to the accompanying drawings. Obviously, the described embodiments are only part but not all of the embodiments of the present disclosure. All other embodiments obtained by those of ordinary skill in the art based on the embodiments in the present disclosure, without creative efforts, fall within the protection scope of the present disclosure.

The terms used in the embodiments of the present disclosure are for the purpose of describing particular embodiments only, and are not intended to limit the present disclosure. The singular forms “a/an”, “said” and “the” as used in the embodiments of the present disclosure and the appended claims are intended to include the plural forms as well, unless otherwise clearly indicated in the context, and the term “a plurality of” generally means at least two.

It should be understood that the term “and/or” as used herein describes only an association relationship between associated objects, indicating three types of possible relationships. For example, A and/or B may indicate the following three cases: A exists alone; both A and B exist; or B exists alone. In addition, the character “/” herein generally indicates an “or” relationship between preceding and following associated objects.

It should be understood that, although the terms first, second, third or the like may be used for description in the embodiments of the present disclosure, these should not be limited to these terms. These terms are only used for a distinguishing purpose. For example, without departing from the scope of the embodiments of the present disclosure, “first” may also be referred to as “second”, and similarly, “second” may also be referred to as “first”.

It should also be noted that the terms “include,” “contain,” or any other variants thereof are intended to cover the nonexclusive inclusion, such that a commodity or device including a series of elements not only includes those elements, but also includes other unclearly listed elements, or also includes the inherent elements of such a commodity or device. Without more limitations, an element defined by the phrase “including an” does not exclude the existence of other same elements in the commodity or device that includes such an element.

The present disclosure provides a self-cleaning maintenance station for an automatic cleaning device. The self-cleaning maintenance station includes a self-cleaning maintenance station body. The self-cleaning maintenance station body includes: an accommodating cavity configured to accommodate at least a portion of the automatic cleaning device when the automatic cleaning device returns to the self-cleaning maintenance station; a body base configured to support at least a portion of the automatic cleaning device when the automatic cleaning device returns to the self-cleaning maintenance station and provided with a washing tank facing the accommodating cavity; and a drying fan arranged inside the self-cleaning maintenance station body, located on a side of the accommodating cavity away from the body base and configured to propel drying airflow to at least a portion of the washing tank to dry the washing tank.

According to the self-cleaning maintenance station provided in the present disclosure, by arranging the drying fan and/or the gas heating apparatus above the washing tank, water in the washing tank is prevented from splashing into the drying fan and/or the gas heating apparatus, such that there is no need to perform waterproofing treatments on the drying fan and/or the gas heating apparatus. At least a portion of drying ducts extends in a direction perpendicular to the body base to deliver drying airflow directly towards the washing tank, such that wind noise can be reduced and the user experience can be enhanced.

The embodiments of the present disclosure are described in detail below with reference to the accompanying drawings.

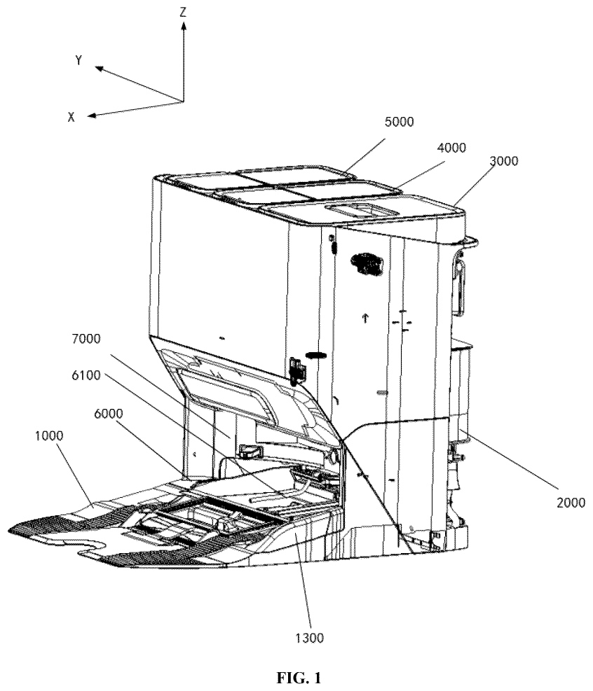

An embodiment of the present disclosure provides a self-cleaning maintenance station for an automatic cleaning device. The self-cleaning maintenance station has a charging function to charge the automatic cleaning device, a dust collection function to collect garbage in a dust box of the automatic cleaning device, a washing function to wash a mop of the automatic cleaning device, and a drying function to dry the mop of the automatic cleaning device. An embodiment of the present disclosure provides a self-cleaning maintenance station. As an example, FIG. 1 is a schematic diagram of an overall structure of a self-cleaning maintenance station according to an embodiment of the present disclosure.

In order to more clearly describe the behavior of the self-cleaning maintenance station, the directions are defined as follows: the self-cleaning maintenance station may be calibrated by the following three mutually perpendicular axes as defined: a transverse axis Y, a front-back axis X, and a central vertical axis Z. The direction opposite to the arrow of the front-back axis X is marked as “rearward”, in which case the automatic cleaning device enters the self-cleaning maintenance station, and the direction following the arrow of the front-back axis X is marked as “forward”, in which case the automatic cleaning device leaves the self-cleaning maintenance station. The transverse axis Y essentially indicates the direction of the width of the self-cleaning maintenance station body. The vertical axis Z indicates the direction extending upward from the bottom surface of the self-cleaning maintenance station.

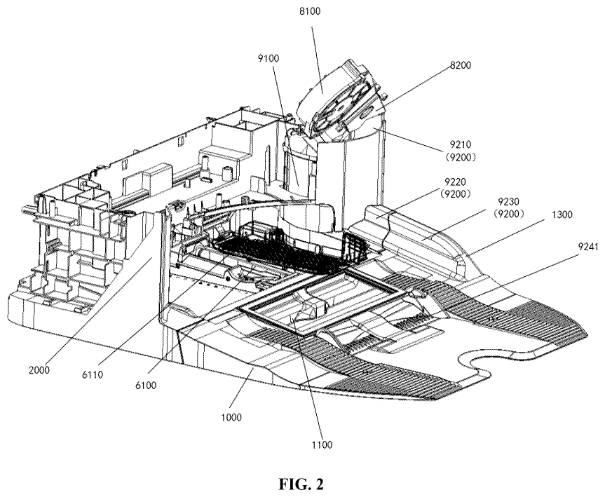

As shown in FIGS. 1 and 2, the self-cleaning maintenance station includes a self-cleaning maintenance station body 2000 and a self-cleaning maintenance station base plate 1000. The self-cleaning maintenance station body 2000 has a dust collection bin 3000, a clean water tank 4000 and a sewage tank 5000 which are arranged adjacent to each other in sequence. The dust collection bin 3000 is used to collect garage from the automatic cleaning device. The automatic cleaning device, such as a sweeping and mopping integrated machine, can return to the self-cleaning maintenance station after completing cleaning tasks to perform a dust collection operation. The garbage collected in a dust box of the automatic cleaning device can be collected into the dust collection bin 3000 during the dust collection operation, such that there is no need for a user to frequently clean up the dust box of the automatic cleaning device, thereby reducing users' workload.

The automatic cleaning device can return to the self-cleaning maintenance station during or after a cleaning operation to wash its wet cleaning module. The clean water tank 4000 is used to provide clean water for washing the wet cleaning module including, for example, a mop, by the automatic cleaning device, and the sewage tank 5000 is used to collect sewage generated after washing is completed.

The self-cleaning maintenance station body 2000 includes an accommodating cavity 7000 and a body base 6000. The accommodating cavity 7000 is configured to accommodate at least a portion of the automatic cleaning device when the automatic cleaning device returns to the self-cleaning maintenance station. The body base 6000 is configured to support at least a portion of the automatic cleaning device when the automatic cleaning device returns to the self-cleaning maintenance station and provided with a washing tank 6100 facing the accommodating cavity 7000. The washing tank 6100 is used to accommodate at least a portion of the wet cleaning module of the automatic cleaning device, such that the mop of the automatic cleaning device is washed in the washing tank 6100.

The self-cleaning maintenance station base plate 1000 is detachably assembled with the self-cleaning maintenance station body 2000. Specifically, the self-cleaning maintenance station base plate 1000 is detachably assembled with the body base 6000, and supports a portion of the automatic cleaning device when the automatic cleaning device returns to the self-cleaning maintenance station. The self-cleaning maintenance station base plate 1000 is provided with an inclined top surface, which facilitates the return of the automatic cleaning device to the self-cleaning maintenance station to perform various operations.

Specifically, when returning to the self-cleaning maintenance station for performing a washing operation, the automatic cleaning device returns to the self-cleaning maintenance station a backward direction, with at least a portion of the wet cleaning module located at a rear portion of the automatic cleaning device being accommodated in the washing tank 6100 of the body base 6000 to perform the washing operation. When returning to the self-cleaning maintenance station for charging, dust collection, and drying operations, the automatic cleaning device returns to the self-cleaning maintenance station. In this case, the wet cleaning module at the rear portion of the automatic cleaning device is located on the self-cleaning maintenance station base plate 1000, rather than inside the accommodating cavity 7000.

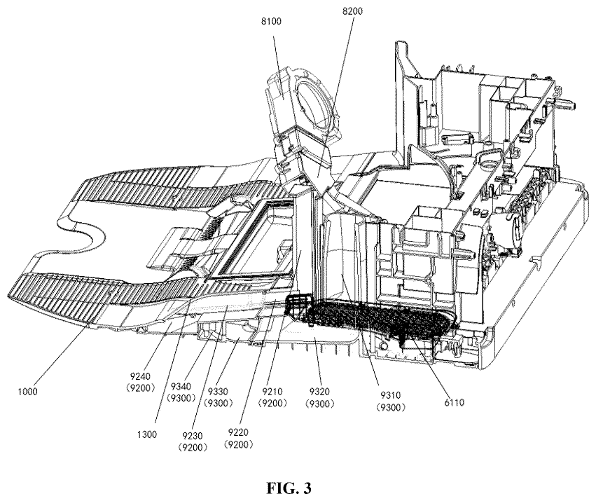

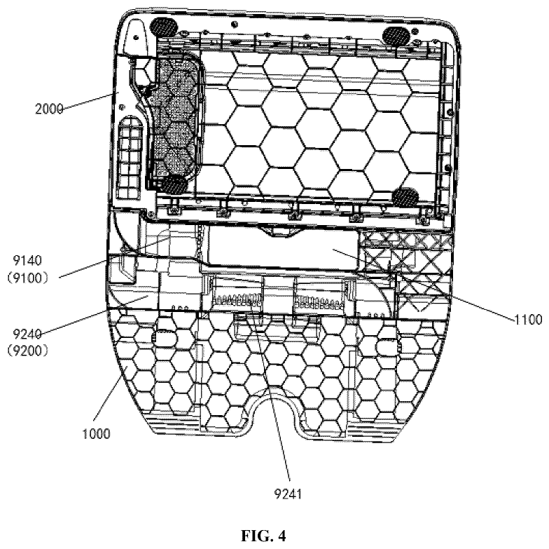

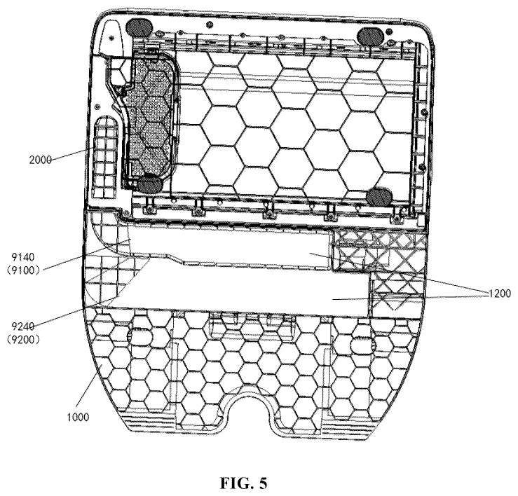

FIG. 2 is a partial structural schematic diagram of the self-cleaning maintenance station according to an embodiment of the present disclosure; FIG. 3 is a partial sectional structural schematic diagram of the self-cleaning maintenance station according to an embodiment of the present disclosure; FIG. 4 is a schematic bottom view of the self-cleaning maintenance station with a cover plate closing an air duct not shown according to an embodiment of the present disclosure; and FIG. 5 is a schematic bottom view of the self-cleaning maintenance station according to an embodiment of the present disclosure.

As shown in FIG. 1 to FIG. 5, the self-cleaning maintenance station further includes a drying fan 8100 arranged in the self-cleaning maintenance station body 2000, located on a side of the accommodating cavity 7000 away from the body base 6000, and configured to propel drying airflow to at least a portion of the washing tank 6100 to dry the washing tank 6100, so as to avoid the breeding of bacteria and the production of unpleasant odors because the washing tank 6100 is in a damp state. Specifically, the drying fan 8100 is arranged at a larger distance above the washing tank 6100. Compared with the solution that the drying fan is arranged close to the washing tank, this prevents water splashing from the washing tank onto the drying fan, thereby avoiding an operation malfunction of the drying fan.

As shown in FIG. 1 to FIG. 5, the self-cleaning maintenance station further includes a gas heating apparatus 8200 also arranged in the self-cleaning maintenance station body 2000, located downstream of the drying fan 8100, also located on the side of the accommodating cavity 7000 away from the body base 600, and configured to heat the airflow propelled by the drying fan 8100. The gas heating apparatus 8200 is for example a PTC heater. The PTC heater consists of a PTC ceramic heating element and an aluminum tube. This type of PTC heating element has the advantages of low thermal resistance and high heat exchange efficiency, and is an automatic constant-temperature energy-saving electric heater. Its outstanding safety feature is that it will not generate a surface “red-hot” phenomenon common in heaters like electric heating tubes under all operational conditions, thereby eliminating potential safety hazards like burns or fires.

In some embodiments, as shown in FIG. 1 to FIG. 5, a first drying air duct 9100 is further arranged in the self-cleaning maintenance station body 2000, delivers the drying airflow heated by the gas heating apparatus 8200, and extends along a side wall of the self-cleaning maintenance station body 2000 in a direction substantially perpendicular to the body base 6000. An air outlet of the first drying air duct 9100 is arranged to face a portion of the washing tank 6100. When the self-cleaning maintenance station performs drying operations, under the driving of the drying fan 8100, the drying airflow, after being heated by the gas heating device 8200, is blown into at least a portion of the washing tank 6100 in the direction substantially perpendicular to the base body 6000. Use of a vertical air duct can reduce wind noise.

In some embodiments, a filter net 6110 is arranged at an end of the washing tank 6100 close to the side wall of the self-cleaning maintenance station body 2000, and is used to filter impurities in sewage in the washing tank 6100. The air outlet of the first drying air duct is arranged to face the filter net. Thus, the drying hot air blows to the filter net 6110 and passes through the filter net 6110 to the lowest point of the washing tank 6100 to dry the lowest point of the washing tank 6100, thereby avoiding unpleasant odors and breeding of bacteria due to sewage remaining in that region.

In some embodiments, after the automatic cleaning device returns to the self-cleaning maintenance station in a forward direction, the self-cleaning maintenance station may perform a drying operation. At least a portion of drying airflow discharged from the first drying air duct 9100 flows away from the filter net 6110 in an extending direction of the washing tank 6100 within a space sandwiched between the automatic cleaning device and the washing tank 6100, such that the drying airflow can completely cover the entire washing tank 6100, thereby performing the drying operation on the entire washing tank 6100.

In some embodiments, the self-cleaning maintenance station includes a second drying air duct 9200. The second drying air duct extends from the side wall of the self-cleaning maintenance station body 2000 via the body base 6000 to the self-cleaning maintenance station base plate 1000, and is configured to deliver at least a portion of drying airflow to a bottom surface of the automatic cleaning device located on the self-cleaning maintenance station base plate to dry the wet cleaning module of the automatic cleaning device. As described above, when returning to the self-cleaning maintenance station for drying, the automatic cleaning device returns to the self-cleaning maintenance station in the forward direction, with its wet cleaning module being supported by the self-cleaning maintenance station base plate 1000.

In some embodiments, as shown in FIG. 1 to FIG. 5, the second drying air duct 9200 includes a first drying air sub-duct 9210, a second drying air sub-duct 9220, a third drying air sub-duct 9230 and a fourth drying air sub-duct 9240 which communicate with each other in sequence. The first drying air sub-duct 9210 extends along the side wall of the self-cleaning maintenance station body 2000 in the direction substantially perpendicular to the body base 6000. The second drying air sub-duct 9220 extends along an edge of the body base 6000 towards the self-cleaning maintenance station base plate 1000. The third drying air sub-duct 9230 extends along an edge of the self-cleaning maintenance station base plate 1000 away from the body base 6000. The fourth drying air sub-duct 9240 extends inside the self-cleaning maintenance station base plate 1000 in a direction substantially perpendicular to the three drying air sub-duct 9230. The heated drying airflow flows through the first drying air sub-duct 9210, the second drying air sub-duct 9220, the third drying air sub-duct 9230 and the fourth drying air sub-duct 9240 in sequence, and is delivered to the self-cleaning maintenance station base plate 1000 to dry the wet cleaning module of the automatic cleaning device on the self-cleaning maintenance station base plate 1000.

In some embodiments, a plurality of air outlets 9241 of the second drying air duct is arranged on a top wall of the self-cleaning maintenance station base plate 1000, communicate with the fourth drying air sub-duct 9240, and is spaced apart along an extending direction of the fourth drying air sub-duct. When the automatic cleaning device returns to the self-cleaning maintenance station in the forward direction, the air outlets 9241 of the second drying air duct directly face the wet cleaning module of the automatic cleaning device, facilitating the drying of the wet cleaning module of the automatic cleaning device.

In some embodiments, the gas heating apparatus 8200 includes a protector configured to perform overheating protection on the gas heating apparatus.

In some embodiments, the self-cleaning maintenance station further includes a temperature sensor arranged in at least one of the first drying air duct and the second drying air duct and configured to monitor temperature of the drying airflow in real time. The self-cleaning maintenance station can adjust an operating state of the gas heating apparatus 8200 in real time based on the detected temperature of the drying airflow, thereby avoiding damage to devices caused by too high temperature of the drying airflow.

In some embodiments, as shown in FIG. 1 to FIG. 5, the first drying air duct 9100 and the second drying air duct 9200 are collectively referred to as air ducts. The first drying air duct 9100 is configured to deliver the drying airflow to at least a portion of the washing tank 6100 to dry the washing tank. The second drying air duct 9200 is configured to deliver the drying airflow to the bottom of the automatic cleaning device located on the self-cleaning maintenance station base plate 1000 to dry the wet cleaning module of the automatic cleaning device.

The drying fan 8100 is arranged in the self-cleaning maintenance station body 2000, and provides power to enable the drying airflow to be delivered in at least one of the first drying air duct 9100 and the second drying air duct 9200. The gas heating apparatus 8200 is arranged between the drying fan and the drying air duct, and is configured to heat the airflow propelled by the drying fan 8100; and the heated airflow is delivered to at least one of the first drying air duct 9100 and the second drying air duct 9200.

In some embodiments, an air inlet of the first drying air duct 9100 and an air inlet of the second drying air duct 9200 are arranged side by side to simultaneously receive the drying airflow. That is, when the self-cleaning maintenance station performs the drying operation, the washing tank 6100 and the wet cleaning module of the automatic cleaning device are dried simultaneously.

Since the drying operations for the washing tank 6100 and the wet cleaning module of the automatic cleaning device need to be completed simultaneously as far as possible during drying, the volumes of air delivered by the first and second drying air ducts are required to be adjusted. Thus, the volumes of air delivered by the first and second drying air ducts are in a predetermined ratio within a unit time to ensure that the washing tank 6100 and the wet cleaning module of the automatic cleaning device are dried simultaneously, thereby improving the drying efficiency.

In some embodiments, a first air inlet area of the air inlet of the first drying air duct and a second air inlet area of the air inlet of the second drying air duct are in a preset ratio for delivering dry heated air, such that the volumes of air delivered by the first and second drying air ducts are in a predetermined ratio within a unit time. In some embodiments, the ratio of the first air inlet area of the air inlet of the first drying air duct to the second air inlet area of the air inlet of the second drying air channel is 1:5 to 4:5, for example, 3:5.

In some embodiments, as shown in FIG. 1 to FIG. 5, as described above, the self-cleaning maintenance station includes the dust collection bin 3000 configured to accommodate garbage from the automatic cleaning device. The self-cleaning maintenance station base plate 1000 is detachably connected to the self-cleaning maintenance station body 2000, and supports a portion of the automatic cleaning device when the automatic cleaning device returns to the self-cleaning maintenance station. The self-cleaning maintenance station base plate 1000 is provided with a dust collection port 1100 configured to communicate with a dust suction port of the automatic cleaning device. When the automatic cleaning device returns to the self-cleaning maintenance station in the forward direction, the dust collection port 1100 in the self-cleaning maintenance station base plate 1000 hermetically communicates with the duct suction port of the automatic cleaning device, thereby facilitating the dust collection operation of the self-cleaning maintenance station. The self-cleaning maintenance station includes a dust collection air duct 9300 which extends from the self-cleaning maintenance station base plate 1000 to the self-cleaning maintenance station body 2000 and which communicates the dust collection port 1100 with the dust collection bin 3000. The drying air duct of the self-cleaning maintenance station, such as the second drying air duct 9200, extends from the self-cleaning maintenance station body 2000 to the self-cleaning maintenance station base plate 1000, and at least portions of the second drying air duct 9200 and the dust collection air duct 9100 extend adjacently in parallel. Such an arrangement makes the layout of the drying air duct and the dust collection air duct more reasonable, such that the self-cleaning maintenance station is compact in overall structure and has a reduced size.

In some embodiments, the second drying air duct 9200 and the dust collection air duct 9300 are at least partially overlapped with each other on the self-cleaning maintenance station base plate, and for example, are at least partially overlapped with each other at the edge of the self-cleaning maintenance station base plate 1000.

In some embodiments, as shown in FIG. 1 to FIG. 5, an edge of one side of the self-cleaning maintenance station base plate 1000 is provided with a protrusion structure 1300, and a portion of the second drying air duct 9200 is formed in the protrusion structure 1300. For example, the third drying air sub-duct 9230 is arranged in the protrusion structure 1300, and a portion of the dust collection air duct 9300 is formed in the self-cleaning maintenance station base plate 1000 and located under protrusion structure 1300.

The protrusion structure 1300 may serve as a positional limit for the automatic cleaning device during its return to the self-cleaning maintenance station, and thus avoids the situation that the automatic cleaning device cannot correctly return to the self-cleaning maintenance station due to positional misalignment when it returns to the self-cleaning maintenance station.

In some embodiments, the dust collection air duct 9300 includes a first dust collection air sub-duct 9310, a second dust collection air sub-duct 9320, a third dust collection air sub-duct 9330, and a fourth dust collection air sub-duct 9340 which communicate with each other in sequence.

The first dust collection air sub-duct 9310 extends along the side wall of the self-cleaning maintenance station body 2000 in the direction substantially perpendicular to the body base 6000. The first dust collection air sub-duct 9310 is arranged parallel and adjacent to the first drying air sub-duct 9210, and is further away from the self-cleaning maintenance station base plate 1000 than the first drying air sub-duct 9210.

The second dust collection air sub-duct 9320 extends along the edge of the body base 6000 towards the self-cleaning maintenance station base plate 1000, and is arranged parallel and adjacent to the second drying air sub-duct 9220. An orthogonal projection of the second drying air sub-duct 9220 on the bottom surface of the body base is overlapped at least partially with an orthogonal projection of the second dust collection air sub-duct 9320 on the bottom surface of the body base.

The third dust collection air sub-duct 9330 extends along the edge of the self-cleaning maintenance station base plate 1000 away from the body base 6000 and is arranged parallel and adjacent to the third drying air sub-duct 9230. An orthogonal projection of the third drying air sub-duct 9230 on the bottom surface of the self-cleaning maintenance station base plate is overlapped at least partially with an orthogonal projection of the third dust collection air sub-duct 9330 on the bottom surface of the self-cleaning maintenance station base plate.

The fourth dust collection air sub-duct 9340 extends inside the self-cleaning maintenance station base plate 1000 in a direction substantially perpendicular to the third dust collection air sub-duct 9330, and is arranged parallel and adjacent to the fourth drying air sub-duct 9240, and is closer to the body base 6000 than the fourth drying air sub-duct 9240.

Due to the detachable connection between the self-cleaning maintenance station base plate 1000 and the body base 6000 of the self-cleaning maintenance station body 2000, when they are connected, the third dust collection air sub-duct 9330 arranged on the self-cleaning maintenance station base plate 1000 communicates with the second dust collection air sub-duct 9320 arranged on the self-cleaning maintenance station body 2000 in a spliced manner, for example, in a hermetically spliced manner. The third drying air sub-duct 9230 arranged on the self-cleaning maintenance station base plate 1000 communicates with the second drying air sub-duct 9220 arranged on the self-cleaning maintenance station body 2000 in a spliced manner, for example, in a hermetically spliced manner.

In some embodiments, the self-cleaning maintenance station base plate 1000 further includes a buckle plate 1200, which, for example, covers the bottom surface of the self-cleaning maintenance station base plate 1000 to close the fourth dust collection air sub-duct 9340 and/or the fourth drying air sub-duct 9340.

Some embodiments of the present disclosure further provide an automatic self-cleaning maintenance system including an automatic cleaning device and the self-cleaning maintenance station as described above.

Finally, it should be noted that the embodiments in the specification are described in a progressive manner, with each embodiment focusing on its difference from other embodiments, and cross reference may be made for the same or similar sections among the embodiments.

The above embodiments are for the purpose of illustrating the technical solutions of the present disclosure only, and are not intended to limit the present disclosure. Although the present disclosure has been described in detail with reference to the foregoing embodiments, those of ordinary skill in the art should understand that: they can still make modifications to the technical solutions described in the foregoing embodiments, or make equivalent substitutions to some of the technical features. These modifications or substitutions do not deviate the essence of the corresponding technical solutions from the spirit and scope of the technical solutions of the embodiments of the present disclosure.

1. A self-cleaning maintenance station for an automatic cleaning device, wherein the self-cleaning maintenance station comprises a self-cleaning maintenance station body, and the self-cleaning maintenance station body comprises:
an accommodating cavity configured to accommodate at least a portion of the automatic cleaning device when the automatic cleaning device returns to the self-cleaning maintenance station;
a body base configured to support at least a portion of the automatic cleaning device when the automatic cleaning device returns to the self-cleaning maintenance station and provided with a washing tank facing the accommodating cavity; and
a drying fan arranged inside the self-cleaning maintenance station body, located on a side of the accommodating cavity away from the body base, and configured to propel drying airflow to at least a portion of the washing tank to dry the washing tank.

2. The self-cleaning maintenance station according to claim 1, wherein the self-cleaning maintenance station body further comprises:
a gas heating apparatus arranged downstream of the drying fan, also located on the side of the accommodating cavity away from the body base, and configured to heat airflow propelled by the drying fan.

3. The self-cleaning maintenance station according to claim 1, wherein the self-cleaning maintenance station body further comprises:
a first drying air duct, extending along a side wall of the self-cleaning maintenance station body in a direction substantially perpendicular to the body base, wherein an air outlet of the first drying air duct is arranged to face a portion of the washing tank.

4. The self-cleaning maintenance station according to claim 3, wherein a filter net is arranged at an end of the washing tank close to the side wall of the self-cleaning maintenance station body, and the air outlet of the first drying air duct is arranged to face the filter net.

5. The self-cleaning maintenance station according to claim 3, wherein the self-cleaning maintenance station body further comprises:
a self-cleaning maintenance station base plate configured to be detachably assembled with the body base and support a portion of the automatic cleaning device when the automatic cleaning device returns to the self-cleaning maintenance station.

6. The self-cleaning maintenance station according to claim 5, further comprising a second drying air duct, wherein the second drying air duct extends from the side wall of the self-cleaning maintenance station body via the body base to the self-cleaning maintenance station base plate, and is configured to deliver at least a portion of the drying airflow to a bottom surface of the automatic cleaning device located on the self-cleaning maintenance station base plate to dry a wet cleaning module of the automatic cleaning device.

7. The self-cleaning maintenance station according to claim 6, wherein the second drying air duct comprises a first drying air sub-duct, a second drying air sub-duct, a third drying air sub-duct and a fourth drying air sub-duct which successively communicate with each other, wherein
the first drying air sub-duct extends along a side wall of the self-cleaning maintenance station body in the direction substantially perpendicular to the body base;
the second drying air sub-duct extends along an edge of the body base towards the self-cleaning maintenance station base plate;
the third drying air sub-duct extends along an edge of the self-cleaning maintenance station base plate away from the body base; and
the fourth drying air sub-duct extends inside the self-cleaning maintenance station base plate in a direction substantially perpendicular to the three drying air sub-duct.

8. The self-cleaning maintenance station according to claim 7, wherein a plurality of air outlets of the second drying air duct is arranged on a top wall of the self-cleaning maintenance station base plate and spaced apart along an extending direction of the fourth drying air sub-duct.

9. The self-cleaning maintenance station according to claim 2, wherein the gas heating apparatus comprises a protector configured to perform overheating protection on the gas heating apparatus.

10. The self-cleaning maintenance station according to claim 6, further comprising a temperature sensor arranged in at least one of the first drying air duct and the second drying air duct and configured to monitor temperature of the drying airflow in real time.

11. A self-cleaning maintenance system, comprising an automatic cleaning device and a self-cleaning maintenance station, wherein the self-cleaning maintenance station comprises a self-cleaning maintenance station body, and the self-cleaning maintenance station body comprises:
an accommodating cavity configured to accommodate at least a portion of the automatic cleaning device when the automatic cleaning device returns to the self-cleaning maintenance station;
a body base configured to support at least a portion of the automatic cleaning device when the automatic cleaning device returns to the self-cleaning maintenance station and provided with a washing tank facing the accommodating cavity; and
a drying fan arranged inside the self-cleaning maintenance station body, located on a side of the accommodating cavity away from the body base, and configured to propel drying airflow to at least a portion of the washing tank to dry the washing tank.

12. The self-cleaning maintenance system according to claim 11, wherein the self-cleaning maintenance station body further comprises:
a gas heating apparatus arranged downstream of the drying fan, also located on the side of the accommodating cavity away from the body base, and configured to heat airflow propelled by the drying fan.

13. The self-cleaning maintenance system according to claim 11, wherein the self-cleaning maintenance station body further comprises:
a first drying air duct, extending along a side wall of the self-cleaning maintenance station body in a direction substantially perpendicular to the body base, wherein an air outlet of the first drying air duct is arranged to face a portion of the washing tank.

14. The self-cleaning maintenance system according to claim 13, wherein a filter net is arranged at an end of the washing tank close to the side wall of the self-cleaning maintenance station body, and the air outlet of the first drying air duct is arranged to face the filter net.

15. The self-cleaning maintenance system according to claim 13, wherein the self-cleaning maintenance station body further comprises:
a self-cleaning maintenance station base plate configured to be detachably assembled with the body base and support a portion of the automatic cleaning device when the automatic cleaning device returns to the self-cleaning maintenance station.

16. The self-cleaning maintenance system according to claim 15, wherein the self-cleaning maintenance station body further comprises a second drying air duct, wherein the second drying air duct extends from the side wall of the self-cleaning maintenance station body via the body base to the self-cleaning maintenance station base plate, and is configured to deliver at least a portion of the drying airflow to a bottom surface of the automatic cleaning device located on the self-cleaning maintenance station base plate to dry a wet cleaning module of the automatic cleaning device.

17. The self-cleaning maintenance system according to claim 16, wherein the second drying air duct comprises a first drying air sub-duct, a second drying air sub-duct, a third drying air sub-duct and a fourth drying air sub-duct which successively communicate with each other, wherein
the first drying air sub-duct extends along a side wall of the self-cleaning maintenance station body in the direction substantially perpendicular to the body base;
the second drying air sub-duct extends along an edge of the body base towards the self-cleaning maintenance station base plate;
the third drying air sub-duct extends along an edge of the self-cleaning maintenance station base plate away from the body base; and
the fourth drying air sub-duct extends inside the self-cleaning maintenance station base plate in a direction substantially perpendicular to the three drying air sub-duct.

18. The self-cleaning maintenance system according to claim 17, wherein a plurality of air outlets of the second drying air duct is arranged on a top wall of the self-cleaning maintenance station base plate and spaced apart along an extending direction of the fourth drying air sub-duct.

19. The self-cleaning maintenance system according to claim 12, wherein the gas heating apparatus comprises a protector configured to perform overheating protection on the gas heating apparatus.

20. The self-cleaning maintenance system according to claim 16, wherein the self-cleaning maintenance station body further comprises a temperature sensor arranged in at least one of the first drying air duct and the second drying air duct and configured to monitor temperature of the drying airflow in real time.
